(19) United States
(12) Patent Application Publication
(10) Pub. No.: US 2021/0323371 A1
(43) Pub. Date: Oct. 21, 2021

(54) AIR SUSPENSION UNDERBODY CLEARANCE DETECTION SYSTEM AND RELATED METHODS

(71) Applicant: Continental Automotive Systems, Inc., Auburn Hills, MI (US)

(72) Inventors: Matthew Eric Letizio, Farmington Hills, MI (US); Chad Howard Morrison, Oxford, MI (US); Brandon Denver Byal, Rochester Hills, MI (US)

(73) Assignee: Continental Automotive Systems, Inc., Auburn Hills, MI (US)

(21) Appl. No.: 16/853,985

(22) Filed: Apr. 21, 2020

(51) Int. Cl. B60G 17/056; B60R 11/04; B60G 11/27; G01V 8/10

(52) U.S. Cl. CPC B60G 17/0565; B60R 11/04; B60G 11/27; B60G 2500/30; B60G 2202/152; B60G 2400/252; B60G 2401/21; G01V 8/10

(57) ABSTRACT

A method includes detecting whether a request to lower a vehicle is received, and when a request is received, determine potential obstructions under the undercarriage of the vehicle. The method further includes using the map and determining whether any interference with the undercarriage will occur when the vehicle is lowered and lowering the vehicle.

### TECHNICAL FIELD

The disclosure herein relates to air suspension underbody clearance detection.

### TECHNICAL BACKGROUND

When drivers and/or passengers desire to enter or exit a stopped vehicle, it is convenient for the drivers and/or passengers to request for the vehicle to be lowered to ease entering and exiting of the vehicle, or to have the vehicle automatically lower itself for example, in the case of autonomous vehicles. However, if there are obstacles under or near the vehicle, damage can occur to the vehicle such as the underbody, front/rear bumper, side steps, rocker panels, or the bottoms of the doors when opened.

What is needed is a better way to prevent damage to a stopped vehicle due to obstacles under or near the vehicle.

### BRIEF SUMMARY

A method comprises detecting whether a request to lower a vehicle is received, and when a request is received, detect potential obstructions under the undercarriage of the vehicle. The method further includes determining whether any interference with the undercarriage will occur when the vehicle is lowered, and lowering the vehicle when the vehicle is in a stopped position.

In one or more embodiments, the method further includes determining a lowest height to which a vehicle can be lowered without interference with at least one of the undercarriage, bumpers, rockers, side steps, or doors of the vehicle.

In one or more embodiments, the method further includes lowering the vehicle to the lowest height.

In one or more embodiments, detecting the obstructions is done with a measuring device.

In one or more embodiments, the measuring device includes at least one sensor.

In one or more embodiments, the measuring device includes at least one laser.

In one or more embodiments, the measuring device includes at least one camera.

A undercarriage detection system comprises a system including at least one measuring device, the measuring device disposed adjacent to a lower portion of a vehicle, the system including a camera/radar ECU, the system configured to detect objects under the vehicle and to determine possible obstructions under the vehicle, and an air suspension system ECU communicatively coupled with the system, the air suspension system configured to lower the vehicle to a lowest height without interference from obstacles under the vehicle when the vehicle is in the stopped position.

In one or more embodiments, the measuring device includes a proximity sensor.

In one or more embodiments, the measuring device includes a camera.

In one or more embodiments, the system further includes a processor communicatively coupled with a communications module.

### BRIEF DESCRIPTION OF THE DRAWINGS

FIG. 1 illustrates a flowchart illustrating a method of use of the undercarriage detection system, as constructed in accordance with one or more embodiments.

FIG. 2 illustrates a vehicle with a undercarriage detection system, as constructed in accordance with one or more embodiments.

FIG. 3 illustrates a schematic diagram of a undercarriage detection system, as constructed in accordance with one or more embodiments.

These and other embodiments, aspects, advantages, and features of the present invention will be set forth in part in the description which follows and will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims and their equivalents.

### DETAILED DESCRIPTION

The following detailed description includes references to the accompanying drawings, which form a part of the detailed description. The drawings show, by way of illustration, specific embodiments in which the apparatus may be practiced. These embodiments, which are also referred to herein as “examples” or “options,” are described in enough detail to enable those skilled in the art to practice the present embodiments. The embodiments may be combined, other embodiments may be utilized, or structural or logical changes may be made without departing from the scope of the invention. The following detailed description is, therefore, not to be taken in a limiting sense and the scope of the invention is defined by the appended claims and their legal equivalents.

Air suspension systems allow the ride height of each corner of the vehicle to be raised and lowered by any number of different events including driver inputs and CAN bus signals from other systems on the vehicle. An air suspension underbody clearance detection system includes sensors, cameras, vehicle height sensor

The system is used in conjunction with a vehicle-height adjusting device which can include an air suspension system provided with air springs, and valves which adjust the height of the vehicle.

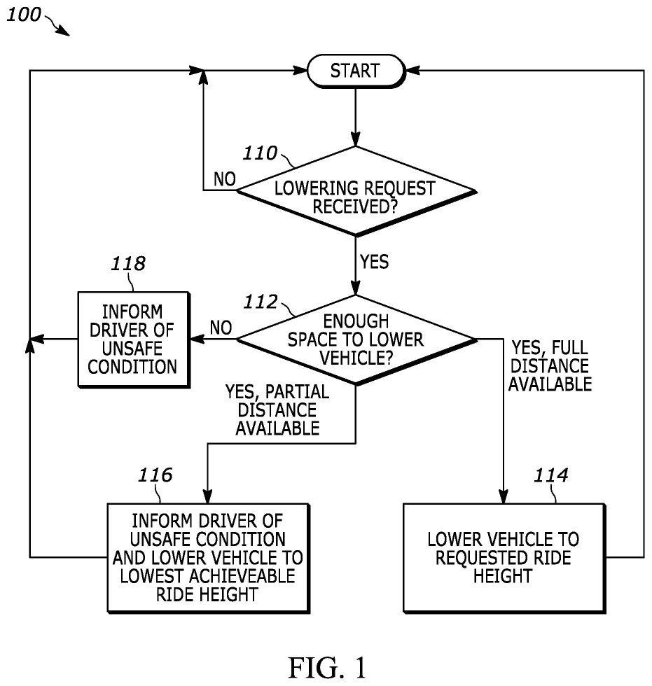

FIG. 1 illustrates a flow chart illustrating the operation 100 of the system. At 110, the system detects whether a request to lower the vehicle has been received, for example when the vehicle is stopped and a passenger or driver wishes to enter or exit the vehicle. If it is determined a request has been received, at 112 the system is used to determine whether there is enough space to lower the vehicle to a predetermined level. In one or more embodiments, the cameras and/or sensors are used in combination to determine potential obstructions under the vehicle. If the full distance is available, at 114 the vehicle is lowered to the predetermined height. If a partial amount of the distance is available, at 116 the driver or passenger is informed of the unsafe condition or obstacles and the vehicle is lowered to the lowest achievable height. If the vehicle cannot be lowered without interference from an obstacle below the vehicle, the driver or passenger are informed.

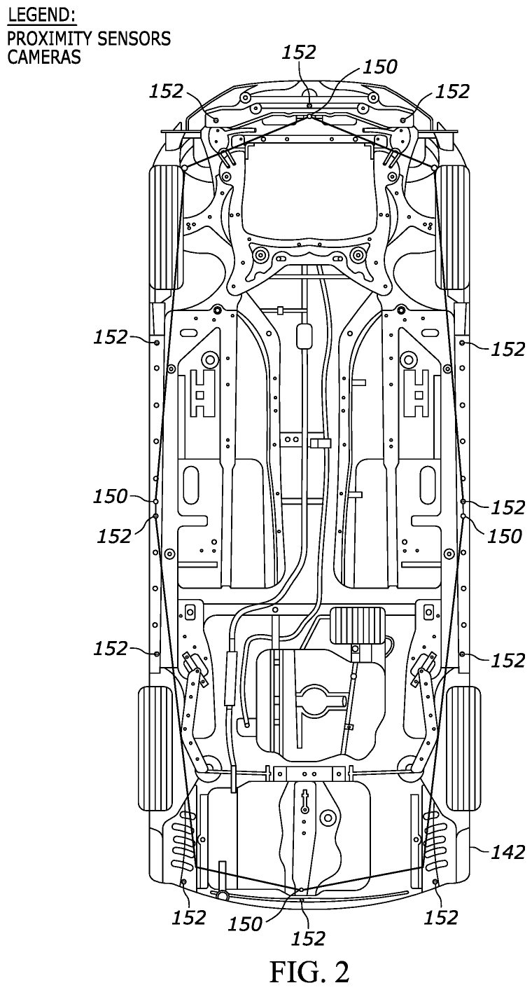

FIG. 2 illustrates an exemplary layout of the system under a vehicle 142. The sensors, such as proximity sensors 152 and cameras 150 are disposed under the front and back bumpers and within the rocker panels.

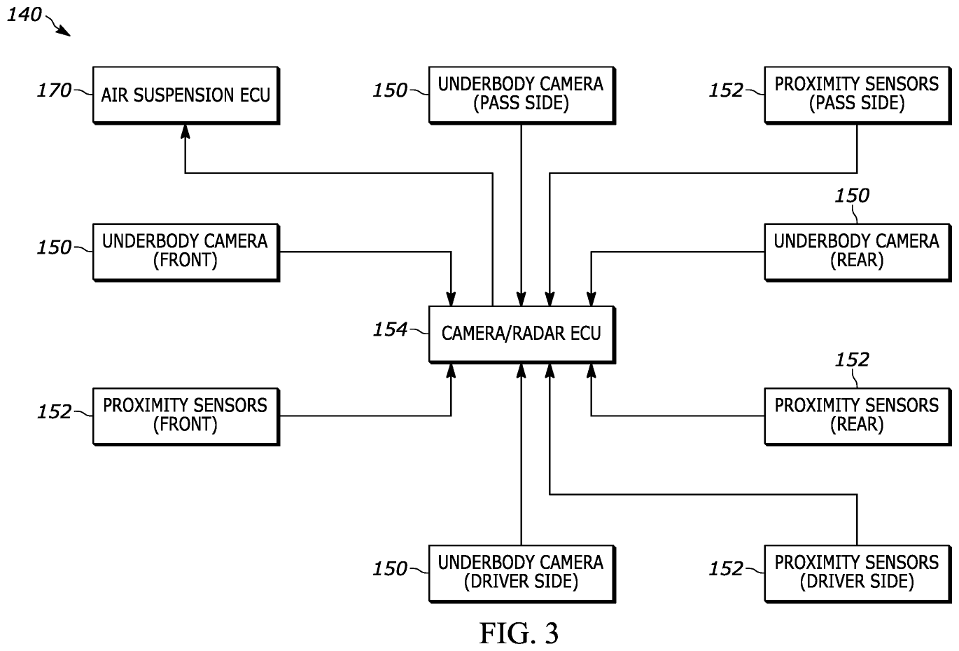

FIG. 3 illustrates the system 140 layout. The system 140 includes measuring devices such as a series of proximity sensors 152, for example disposed along the passenger side of the vehicle, the front and rear of the vehicle, and along the driver side of the vehicle. Similarly, the measuring devices of the system 140 includes one or more underbody cameras 150 along the passenger side, rear and front sides and along the driver side of the vehicle. The sensors 152 and the cameras 150 are communicatively coupled with a camera/radar ECU 154 which in turn is communicatively coupled with the air suspension ECU 170. ECU 154 works in conjunction with the sensors 152 and cameras 150 to determine if there are any obstacles under the vehicle, and to optionally create a map of potential obstructions under the vehicle. The ECU 154 works with the ECU 170 to lower the vehicle to a predetermined height if no obstacles would interfere with lowering the vehicle. ECU 154 is optionally coupled with a communications module configured to inform the driver/passenger if obstacles would interfere with lowering the vehicle. In one or more embodiments, proximity sensors are used to protect the aesthetics of the body work. In one or more, cameras are used, for example, in addition to the proximity sensors to avoid any damage to the unseen undercarriage of the vehicle.

The above description is intended to be illustrative, and not restrictive. Many other embodiments will be apparent to those of skill in the art upon reading and understanding the above description. Embodiments discussed in different portions of the description or referred to in different drawings can be combined to form additional embodiments of the present application. The scope should, therefore, be determined with reference to the appended claims, along with the full scope of equivalents to which such claims are entitled.

1. A method comprising:
detecting whether a request to lower a vehicle is received;
when a request is received, determining whether there are potential obstructions under the undercarriage of the vehicle;
determining whether any interference with the undercarriage will occur with the potential obstructions when the vehicle is lowered; and
lowering the vehicle when the vehicle is in a stopped position.

2. The method as recited in claim 1, further comprising determining a lowest height to which a vehicle can be lowered without interference with at least one of the undercarriage, bumpers, rockers, side steps, or doors of the vehicle.

3. The method as recited in claim 2, further comprising lowering the vehicle to the lowest height.

4. The method as recited in claim 1, determining whether there are potential obstructions under the undercarriage of the vehicle is done with a measuring device.

5. The method as recited in claim 4, wherein the measuring device includes at least one sensor.

6. The method as recited in claim 4, wherein the measuring device includes at least one laser.

7. The method as recited in claim 4, wherein the measuring device includes at least one camera.

8. A undercarriage detection system comprising:
a system including at least one measuring device, the measuring device disposed adjacent to a lower portion of a vehicle;
the system including a camera/radar ECU, the system configured to detect objects under the vehicle and to determine whether the objects under the vehicle with interfere with the vehicle in a lowered position; and
air suspension system ECU communicatively coupled with the system, the air suspension system configured to lower the vehicle to a height without interference from obstacles under the vehicle when the vehicle is in the stopped position.

9. The undercarriage detection system as recited in claim 8, wherein the measuring device includes a proximity sensor.

10. The undercarriage detection system as recited in claim 8, wherein the measuring device includes a camera.

11. The undercarriage detection system as recited in claim 8, further comprising a processor communicatively coupled with a communications module.
